(19) United States
(12) Patent Application Publication
(10) Pub. No.: US 2006/0265853 A1
(43) Pub. Date: Nov. 30, 2006

(54) APPARATUS AND METHOD FOR L-SHAPED CABINET

(76) Inventor: Michael J Povolny, Inver Grove Heights, MN (US)

Correspondence Address: LEMAIRE PATENT LAW FIRM, P.L.L.C., PO BOX 11358, ST PAUL, MN, 55111, US

(21) Appl. No.: 11/382,617

(22) Filed: May 10, 2006

Related U.S. Application Data
(60) Provisional application No. 60/679,701, filed on May 10, 2005.

(51) Int. Cl. B23P 19/00

(52) U.S. Cl. 29/462; 29/469

(57) ABSTRACT

The present invention provides a method and apparatus for constructing an L-shaped cabinet. Such a cabinet can hold equipment that regulates and controls both main and auxiliary electrical power for a set of traffic-signal lights. Service and traffic cabinets house equipment for regulating electrical power and for traffic control. This L-shaped cabinet can incorporate much of the functionality associated with both service and traffic cabinets into an all-in-one design. Additionally, the L-shaped design affords a power-usage (watt hour) meter additional protection from damage. This L-shaped cabinet is configured to utilize the bolt pattern, and foot pattern of standard service cabinets, allowing easy replacement of obsolete existing cabinets. The service cabinet is configured for auxiliary power batteries to be stored inside and utilized. This ability to store and utilize batteries is due in part to the cabinet's being divided into compartments, and providing adequate venting for harmful, corrosive battery gases.

### CROSS REFERENCE TO RELATED APPLICATION

The application claims priority under 35 U.S.C. §119(e) to U.S. Provisional Patent Application Ser. No. 60/679,701 filed May 10, 2005 which is incorporated in its entirety herein.

### FIELD OF THE INVENTION

This invention relates to the field of cabinets for electrical equipment and more specifically to cabinets used to contain operatively coupled field wiring, circuit breakers, batteries, switches and cables used to regulate and control traffic signals, and to a method and apparatus for protectively housing these devices.

### BACKGROUND OF THE INVENTION

Traffic signals are a fixture of modern roads, typically controlling the intersections of these roads. These signals tell drivers such things as when to stop, when to go, and when to use caution when entering an intersection. The switches, circuits, power supply and other devices central to the smooth operation of these traffic signals are typically housed in traffic-signal cabinets and signal-service cabinets located in close proximity to the traffic signals themselves. Typically, the traffic-signal cabinet will contain devices related to the operation of the lights and their proper sequencing, including switches, control equipment, a thermostatically controlled fan and heater, and other related devices. Signal-service cabinets, on the other hand, typically contain devices related to efficiently supplying electrical power to the traffic-signal cabinet and signal lights, including providing a metered recording of the amount of electrical power supplied, a power panel, circuit breakers, a power source and other similar devices.

These cabinets are typically rated based upon some type of industry standard. For example, with regard to traffic-signal cabinets, the National Electrical Manufactures Association (NEMA) has a variety of standard ratings, such as the Type TS1 and Type TS2, just to name a few. As to signal-service cabinets, the NEMA Type-3R, 1, 4, 4× and 12 ratings are known in the art. Signal-service cabinets that meet these NEMA ratings may vary in terms of not only the configuration of the cabinets themselves (i.e., their dimensions), but also in terms of their bolt-pattern foot print, internal racks, size and dimension of doors, and other factors.

Some problems common to signal-service cabinets relate to issues of corrosion due to the combination of water and salt, and designing ways to allow for water to evaporate out of the cabinet. Many modern signal-service cabinets are constructed from aluminum (e.g., an aluminum alloy die casting) or some other metal that manifests a relatively low level of corrosion when compared to, for example, steel. The choice of aluminum is a function of the constant effects of the water, salt and other corrosive elements to which the signal-service cabinets are subject. In short, signal-service cabinets should be weather-tight.

The corrosive effects of salt and water not only corrode the traffic cabinets from the outside, but these same elements can affect the traffic cabinets from the inside. Specifically, water can condense inside the cabinet and damage the electrical components contained therein. One common solution to this problem is to place vents in the traffic cabinet to allow for the condensing water to evaporate out of the cabinet. Once evaporated, the water will pose less of a threat to the electrical devices contained within the cabinet.

With regard to actual installation, a signal-service cabinet is typically mounted on a concrete slab with four anchor rods embedded into the concrete slab, and secured to the slab with a nut on each anchor rod and a washer separating the nut and the signal-service cabinet. Placed between the signal-service cabinet and the concrete slab is typically a rubber gasket to reduce the likelihood that the signal-service cabinet will come into contact with water.

One of the problems faced by many of the standard signal-service cabinets relates to the ability to contain and provide an auxiliary power supply, typically in the form of batteries, in addition to the main power supply. This has become even more of a problem given that many of those who use signal-service cabinets now require that these cabinets have both an auxiliary power supply and a main power supply. This problem has two parts. First, how does one allow for the auxiliary power supply to be placed into a cabinet with the main power supply? Next, how can a cabinet be designed that can incorporate both power supplies while at the same time utilizing the bolt pattern and basic dimensions of the typical signal-service cabinet? The presence of an auxiliary power supply is important in those instances where the main power supply has failed.

Another problem faced by modern service cabinets is how to allow for an easy determination of the amount of power utilized via a particular service cabinet, but at the same time protecting the means by which this power usage is disclosed. More to the point, some modern signal-service cabinets have a power meter showing the amount of power used. This power meter (i.e., the meter box) is typically protected by a transparent material such as Plexiglas™ or Lexan™ and protrudes from the front or back face of the service cabinet. Problems arise, however, in that this meter, while protected, can be damaged or easily sheared off by, for example, an automobile moving in close proximity to, or coming into contact with the front or back face of the service cabinet. Other dangers arise from pedestrians, or individuals on bicycles (e.g., children) tampering with the meter. What is needed is an improved enclosure to address the unresolved problems listed above, as well as other problems that will become apparent upon reading the disclosure below.

### SUMMARY OF THE INVENTION

In some embodiments, the present invention includes an L-shaped cabinet (e.g., L-shaped service cabinet) that solves many of the problems described above. For example, different than prior-art signal-service cabinets, the L-shaped cabinet allows for, in some embodiments, the incorporation of the signal-service meters, main power supply and related equipment, and an auxiliary battery supply into one unit. In some embodiments, the L-shaped cabinet allows for these components to be incorporated while still using a standard service-cabinet bolt pattern for attaching the L-shaped cabinet to an existing concrete ground pad as is known in the art. In some embodiments, additional equipment related to the actual controlling of the signal lights themselves is incorporated. Additionally, the L-shape configuration of the present invention allows for the service meter (e.g., an electrical watt hour meter) to be set back (i.e., recessed) such that, for example, a vehicle moving in close proximity to the service cabinet will first come into contact with the lower portion of the service cabinet, thus lessening the likelihood of coming into contact with the upper portion of the cabinet. Put another way, by coming into contact with the lower portion first, there is less likelihood that the service meter can be sheared off or damaged. And again, by recessing the meter box, the electrical-service meter will be harder for an individual, such as a pedestrian, or a vehicle, such as an automobile, to come into contact with and damage.

The present invention provides for a method, apparatus and means for constructing an L-shaped cabinet to be used to store equipment related to the supplying of electrical power to a set of signal lights. In some embodiments, the apparatus is formed by applying a method comprising folding a first piece of sheet material into a three-sided box frame having three major sides including a first, second and third major side, wherein the first major side and third major side are L-Shaped, and the second major side connects a vertical inner edge of the first major side to a vertical inner edge of the third major side in order to construct an L-shaped cabinet. In some embodiments, the apparatus is an L-shaped cabinet comprising a three-sided box frame with a first major side, a second major side, and a third major side, wherein the first major side and third major side are L-Shaped, and the second major side connects a vertical inner edge of the first major side to a vertical inner edge of the third major side in order to construct an L-shaped cabinet, and wherein the box frame is operatively coupled to one or more additional component pieces, in order to construct an L-shaped cabinet.

Among the many advantages of the L-shaped cabinet are that it can accommodate both main electrical power, and auxiliary power in the form of batteries stored within the L-shaped cabinet itself. Another advantage of the L-shaped cabinet is that it is configured to be safer than other service cabinets because the meter box is recessed in the inner elbow of the L-shape of the cabinet and faces away from traffic. This lessens the likelihood that the meter box on the exterior of the cabinet could be sheared off when impacted by, for example, an automobile. Similarly, this recessed electrical watt hour meter lessens the likelihood that a child could tamper with the meter. An additional advantage of the L-shaped cabinet is that it is configured to fit the bolt pattern of traditional service cabinets, for mounting to a concrete pad in the ground. In some embodiments, the functionality of both the traffic-signal cabinets and signal-service cabinets are combined into the present invention to provide an all-in-one cabinet.

In some embodiments, the L-shaped cabinet is formed by folding various pieces of sheet metal into certain required forms. For example, in some embodiments, a method is employed wherein a piece of sheet of metal is folded into a three-sided box frame. Next, separate pieces of sheet metal are folded into a back panel, a shelf rack, a shelf, a shelf stop, a base plate and bracket, a small lower door, a back panel rail, a dead front, a divider with knock outs, a front service door, a rear service door, a lower section roof, a door stiffener (or stiffeners), a top vented brace, an upper roof, a wireway cover (the wireway being a space through which electrical wires pass), a lower barrier, a raceway divider, and a stand off. Once these pieces are formed using, for example, a folding method, the pieces are attached together. A back panel is attached onto the three-sided box frame using a lock-and-hinge mechanism. Then, the shelf rack and shelves are attached onto the three-sided box frame. Once the shelf racks are attached, the shelf stop is inserted into the three-sided box frame. Next, the three-sided box frame is attached onto the base plate. The front and back doors are then attached to the three-sided box frame using a lock-and-hinge configuration. These doors are stiffened using various door stiffeners. Dividers are then inserted, and attached to the three-sided box frame, to divide up the L-shaped cabinet into various compartments. An upper roof is next attached to the top of the three-sided box frame, and a top vent brace is inserted to cover the space between the upper roof and the top of the three-sided box frame.

In some embodiments, the L-shaped cabinet includes various folded or stamped pieces including, for example, a three-sided box frame, a back panel, a shelf rack, a shelf, a shelf stop, a base plate and bracket, a small lower door, a back panel rail, a dead front, a divider with knock outs, a front service door, a rear service door, a lower-section roof, a door stiffener, a top vented brace, an upper roof, a wireway cover, a lower barrier, a raceway divider and a stand off. Each of these pieces is operatively coupled to form a single L-shaped cabinet.

In some embodiments, the L-shaped cabinet is constructed using an apparatus for folding a piece of sheet metal into a three-sided box frame, and then using the same or a different apparatus for folding separate pieces of metal into a back panel, a shelf rack, a shelf, a shelf stop, a base plate and bracket, a small lower door, a back panel rail, a dead front, a divider with knock outs, a front service door, a lower section roof, a door stiffener (or stiffeners), a top vented brace, an upper roof, a wireway cover, a lower barrier, a raceway divider, and a stand off. Once the various pieces that make up the service cabinet are formed, other apparatus are employed to attach these pieces together including, for example, an apparatus for attaching the back panel onto the back of the three-sided box frame using a lock-and-hinge mechanism (i.e., forming a rear service door), an apparatus for attaching the shelf rack and shelves onto the three-sided box frame, an apparatus for attaching the shelf stop into the three-sided box frame, an apparatus for attaching the three-sided box frame onto a base plate, an apparatus for attaching the front door to the three-sided box frame using a lock-and-hinge configuration, an apparatus for attaching various door stiffeners to the back and front service doors, an apparatus for inserting dividers into the three-sided box frame, an apparatus for attaching the upper roof to the top pf the three-sided box frame, and an apparatus for attaching the top vent brace to the top of the three-sided box frame to cover the space between the upper roof and the top of the three-sided box frame.

### BRIEF DESCRIPTION OF THE DRAWINGS

FIG. 1 is a front view of an L-shaped cabinet 100.

FIG. 2 is a front view of an L-shaped cabinet 100 with the service door removed.

FIG. 3 is a back view of an L-shaped cabinet 100.

FIG. 4 is a side view of an L-shaped cabinet 100.

FIG. 5 is a bottom view of an L-shaped cabinet 100.

FIG. 6 is a back perspective view of an L-shaped cabinet 100.

FIG. 7 is a back perspective view of an L-shaped cabinet 700 with a split-rear service doors.

FIG. 8 is a back perspective exploded view of the various components that are assembled to create the L-shaped cabinet 800 having both regular front and rear service doors, or optional split front and rear service doors.

FIG. 9 is a cut-and-fold diagram for a piece of sheet metal 900.

FIG. 10 is a cut-and-fold diagram for a piece of sheet metal 1000 with foldable base plate and upper roof described.

### DESCRIPTION OF EMBODIMENTS

In the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention.

The leading digit(s) of reference numbers appearing in the Figures generally corresponds to the Figure number in which that component is first introduced, such that the same reference number is used throughout to refer to an identical component which appears in multiple Figures. Signals and connections may be referred to by the same reference number or label, and the actual meaning will be clear from its use in the context of the description.

In some embodiments, L-shaped cabinet is an outdoor electrical cabinet. In some embodiments, the L-shaped cabinet contains electrical circuitry to distribute electrical power to a traffic-signal system. In some embodiments, this electrical power is alternating-current-electrical power, while, in other embodiments, the power is converted to direct-current-electrical power. In some embodiments, the power is converted to low-voltage electrical power.

In some embodiments, the L-shaped cabinet is an L-shaped traffic-signal cabinet which contains auxiliary power that includes batteries, and circuitry to distribute electrical power to a traffic signal system.

In some embodiments, the L-shaped cabinet is used to house circuitry used to control signal lights, and a traffic-signal system. In some embodiments, the functionality used to describe the L-shaped service cabinet, L-shaped traffic cabinet, and L-shaped signal cabinet can be combined together, used separately, or used in some combination within the L-shaped cabinet.

In some embodiments, the L-shaped cabinet includes a variety of subcomponents including, for example, a rectangular three-sided box frame, a back panel, a shelf rack, a shelf (or shelves), a shelf stop, a base plate and bracket, a small lower door, a back panel rail, a dead front, a divider (or dividers) with knockouts, a front door, a lower section roof, a door stiffener (or stiffeners), a top vented brace, an upper roof, a wireway cover, a lower barrier, a raceway divider, and a stand off. In some embodiments, the back panel and shelf rack have rack provisions. In some embodiments, at least some of these subcomponents and the cabinet frame are made from an aluminum material. In some embodiments, there are provisions for a 19-inch (48.26-cm) Electronics Industry Association (EIA) rack to accommodate various types of computer hardware common to many modern traffic-signal systems.

In addition, in some embodiments, the recessed upper portions provide a protected space in which to externally mount a power meter (referenced below, for example, as meter box 131). In some embodiments, this externally mounted power meter is optional since no power meter is required for the L-shaped cabinet to be useful. For example, in an implementation where the L-shaped cabinet it used in an L-shaped signal cabinet configuration, an external power meter might not be used. And again, for example, in those instances where the L-shaped cabinet is used for storage, an external meter power meter might not be used. In still other embodiments, a power meter might be internally mounted and accessed through either a front or rear service door, window, or pair of front service doors or rear service doors.

In some embodiments, the 19-inch (48.26-cm) EIA racks allow for the L-shaped cabinet to have additional functionality. In some embodiments, for example, these racks allow for traffic-control equipment (e.g., computers, circuitry, software), normally reserved for the above referenced traffic-signal cabinets, to be placed into the L-shaped cabinet. The L-shaped cabinet allows for both front and rear access to this equipment such that, for example, if the traffic-control equipment is mounted in the front of the L-shaped cabinet it can be accessed from the rear, and if the equipment is mounted in the rear, it can be accessed from the front. In some embodiments, traffic-control equipment is mounted in a lower compartment, and is accessible from a front service door, a rear service door, or both. In some embodiments, an auxiliary power supply including batteries can be accessed via the front service door, the rear service door, or both. In some embodiments, the circuit breakers and related devices can be accessed from the front service door, the rear service door, or both.

In some embodiments, for example, aluminum is the material used for the cabinet and its subcomponents and the thickness of sheet aluminum used is 0.125 inches (0.32 cm), 0.188 inches (0.48 cm) or some other suitable thickness. In some embodiments, the aluminum is powder coated to increase its durability to the elements. A common powder-coating color is No. 70 Grey and is used for some embodiments. Other colors may also be used as are commonly known in the art. In other embodiments, steel (e.g., painted or powder-coated to prevent corrosion), stainless steel, and/or plastic (such as electrical-grade PVC (poly-vinyl chloride) or ABS) are used for all or at least some of the components, frames, and other portions of the L-shaped cabinet.

In some embodiments, the L-shaped cabinet is compliant with the requirements of NEMA 3R. It is constructed from, for example, 0.125-inch (0.32-cm) 5052-H32 anodized aluminum. Each door (e.g., front and rear) in the cabinet is sealed with a neoprene gasket to reduce the amount of moisture that can enter either the upper compartment (typically used for line-voltage components(e.g., 110 volts or 220 volts) or the lower compartment (typically used for low-voltage components (e.g., 24 volts or 12 volts). In some embodiments, all the low-voltage compartments are separated from the high-voltage compartments by a divider wall (e.g., sheet steel or aluminum, in some embodiments). The hardware itself is of a non-corroding type.

In some embodiments, for example, some or all of the components of the L-shaped cabinet are made from a polymer or plastic material such as acrylonitrile butadiene styrene (“ABS”) or other suitable polymer. In addition to the non-corroding characteristics of polymer, an L-shaped cabinet made, at least partially, from polymer is light, but durable. In some embodiments, the above-described three-sided box frame and components that make up the L-shaped cabinet are molded via injection molding and fastened together via bolts, adhesive glues, foam sticky tapes, or other suitable means.

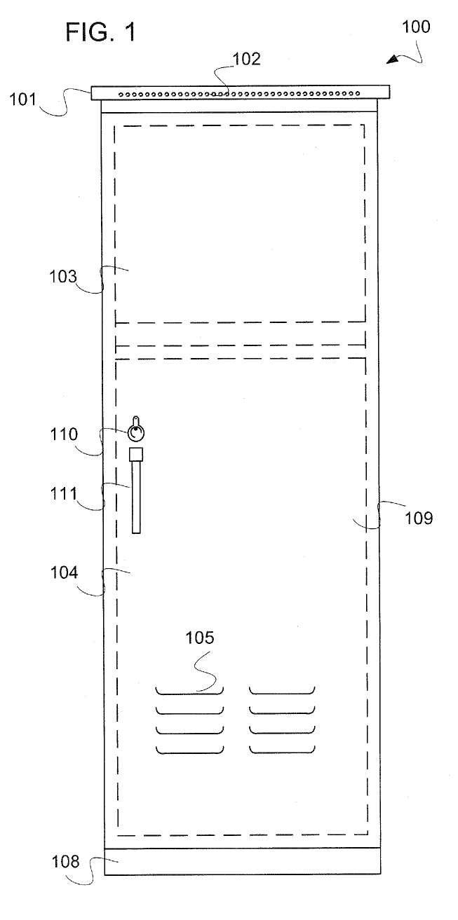

FIG. 1 is a front view of an L-shaped cabinet 100. Operatively coupled to the L-shaped cabinet 100 is an upper roof 101, a top vent brace 102, an upper section 103, a lower section 104, vented louvers 105, a police lock 110, three-point latch with padlocking provisions 111, a base plate 108 and front service door 109. In some embodiments, the L-shaped cabinet 100 is, for example, 60-inches (152.4-cm) high, 23-inches (58.42-cm) wide, and 17-inches (43.18-cm) deep. While the top vent brace 102 depicts vent holes, in some embodiments, these vent holes are not visible on the surface of the L-shaped cabinet 100, but rather are partially covered by the over hang of the upper roof 101. In some embodiments, the L-shaped cabinet 100 has other dimensions, which are determined through empirical testing and/or modeling.

In some embodiments, a sheet of aluminum of an appropriate thickness (e.g., 0.32 cm) is taken and used to form a rectangular three-sided box frame with open sides running along the length and width of the frame. This rectangular three-sided box frame, and the components associated therewith, is formed by taking the sheet of aluminum and cutting it (as described below) with, for example, a laser, water-jet cutter, jig saw or a computer-numerical controlled (“CNC”) punch. Once the appropriate cuts are made, a brake press or other suitable mechanical or hydraulic press is used to fold (as described below) the sheet of aluminum.

In some embodiments, a lateral cut is made approximately two-thirds (⅔) the way down the sheet of aluminum from the edge of one side to the other edge. From this lateral cut, a perpendicular second cut is made. As a result of the lateral cut and the second cut, two flaps are formed that are then folded out. This method for cutting and folding to create the three-sided box frame is more fully described below.

In some embodiments, rather than, for example, cutting and folding a sheet of aluminum to form a three-sided box frame, separate pieces of aluminum are cut and fastened together to form the three-sided box frame. In some embodiments, these pieces of aluminum are fastened via welding them together using, for example, metal-inert gas (MIG), tungsten-inert gas (TIG) or some other welding technology and associated technique. In still other embodiments, these pieces of aluminum are bolted or riveted together.

Added to this three-sided box frame are the various subcomponents described above. These subcomponents are formed using various folding techniques used in conjunction with a suitable type of mechanical or hydraulic press known in the art. Once folded, these subcomponents are welded or bolted onto the three-sided box frame. For example, a back panel is formed and mounted onto the back of the three-sided box frame using a lock-and-hinge mechanism such that the back panel can serve as a rear service door. Additionally, a shelf rack and shelves are optionally attached by being bolted or welded into the three-sided box frame. Next, shelf stops are inserted into the three-sided box frame by either being bolted or welded into place. Then, the three-sided box frame is welded onto a base plate that forms the bottom of the L-shaped cabinet. A front service door is then mounted onto the three-sided box frame using two lock-and-hinge configurations. Various door stiffeners are welded onto the front door to strengthen this door. An additional step is to insert dividers into the three-sided box frame to divide up the shelf rack and shelves into two or more divided compartments. This division into sections will, in large part, depend upon the types of equipment that will be used in the L-shaped cabinet and the requirements thereof (e.g., the use of a main and auxiliary power supply will require two separate compartments). To the top of the three-sided box frame a top vent brace and upper roof will be added. The top vent brace will allow water to escape upon being evaporated from the interior of the L-shaped cabinet. In some embodiments, many of the above-referenced subcomponents may be attached or fastened together by being welded, bolted or through some other manner known in the art. In some embodiments, two or more of the separately described pieces are formed as a single piece.

In some embodiments, above-described three-sided box frame and subcomponents, are manufactured using, for example, a computer-aided water saw, or a metal saw, or the three-sided box frame and components are cast (e.g., die cast).

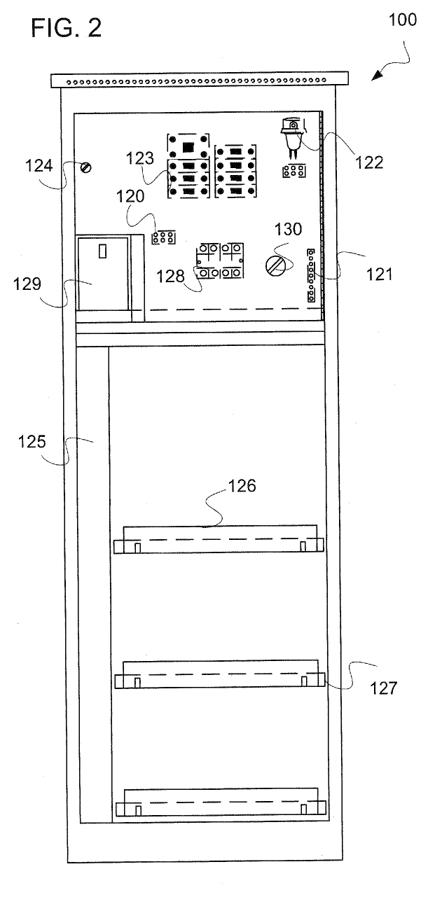

FIG. 2 is a front view of an L-shaped cabinet 100 with the front service door removed such that interior components can be viewed. Depicted in this illustration is a ground-connection bar 121, a interior-mounted photocell 122, a circuit breaker 123, a battery-backup bypass switch 124, a wireway 125, a shelf 126, a shelf rack 127, a four-pin contact 128, additional space for interior components 129, a three-pin terminal block 120, and a test switch 130. In some embodiments, the width of the compartments is 18.5 inches (46.99 cm), and the lighting wireway is 3.5-inches (8.89-cm) wide. In some embodiments, the L-shaped cabinet 100 has other dimensions for width and the lighting or electrical power wireway, the efficiency of which is determined through empirical testing and/or modeling. In some embodiments, the above described L-shaped cabinet 100 can be used for other purposes including storing auxiliary equipment related to traffic control.

An additional purpose of the top vents brace is to allow for the various gases (e.g., hydrogen gas) generated by certain auxiliary batteries contained within the L-shaped cabinet 100 to be vented out of the cabinet. Absent such vents, the electrical devices contained within the cabinet could be damaged by these gases.

In some embodiments, the L-shaped cabinet 100 has high- and low-voltage power sources and related distribution. The high-voltage power supply is provided by an external main power source, while the low-voltage power supply is supplied by an internal auxiliary source, for example, batteries. The high-voltage power source and low-voltage power source are kept in separate compartments through the use of barriers. In some embodiments, the lower barrier is welded into place. In some embodiments, the lower barrier is bolted and sealed into place. In some embodiments, the lower barrier is folded into place.

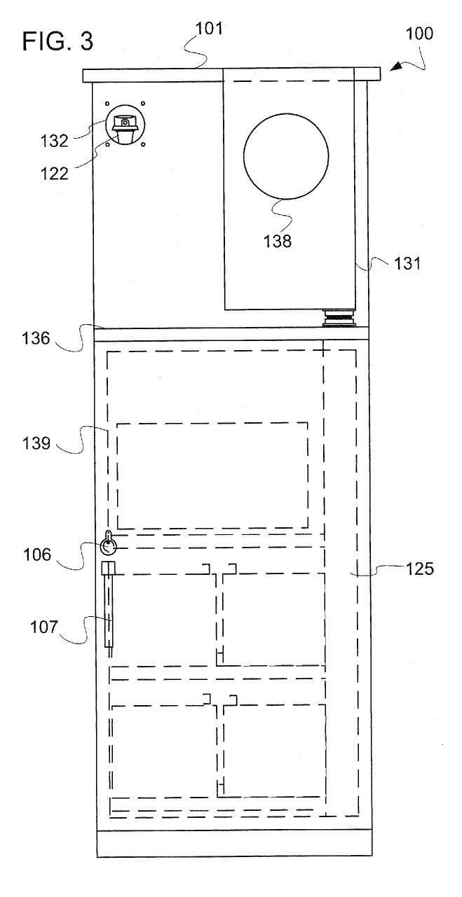

FIG. 3 is a back view of an L-shaped cabinet 100 with a meter box 131, a window 132 for a photocell 122, a wireway 125, a police lock 106, a three-point latch with padlocking provisions 107, a lower roof 136, an upper roof 101, a meter viewing window 138, and a rear service door 139. In some embodiments, various door stiffeners are welded onto the rear service door to strengthen this door. In some embodiments, the wireway is, for example, 3.5-inches (8.89-cm) wide. In some embodiments, the photocell window 132 is made of Lexan and is approximately 4-inches square (10.16 cm by 10.16 cm).

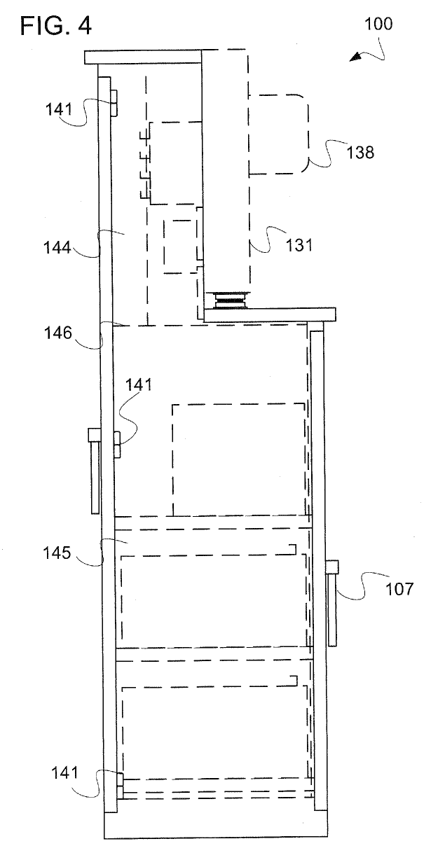

FIG. 4 is a side view of an L-shaped cabinet 100 with three hinges 141, a meter viewing window 138, a meter box 131, an upper compartment 144, a lower compartment 145, and a lower barrier 146. In some embodiments, the upper compartment is, for example, 20.25-inches (51.44-cm) high, and 20-inches (50.8-cm) wide, and 8-inches (20.32-cm) deep. In some embodiments, the lower compartment is 35.75-inches (90.81-cm) high, and ranges between 14-inches (35.56-cm) and 10-inches (25.4-cm) wide. In still other embodiments, for example, the meter box extends from the upper compartment 9-inches (22.86-cm) including, for example, the viewing window. In some embodiments, the L-shaped cabinet 100 has other dimensions for lower compartment height and width, and distance by which the meter box extends from the upper compartment. In some embodiments, the L-shaped cabinet 100 does not have a meter box 131. In some embodiments, the dimensions of the upper and lower compartments can be determined through empirical testing and/or modeling, while maintaining the design and general L-shape of the cabinet.

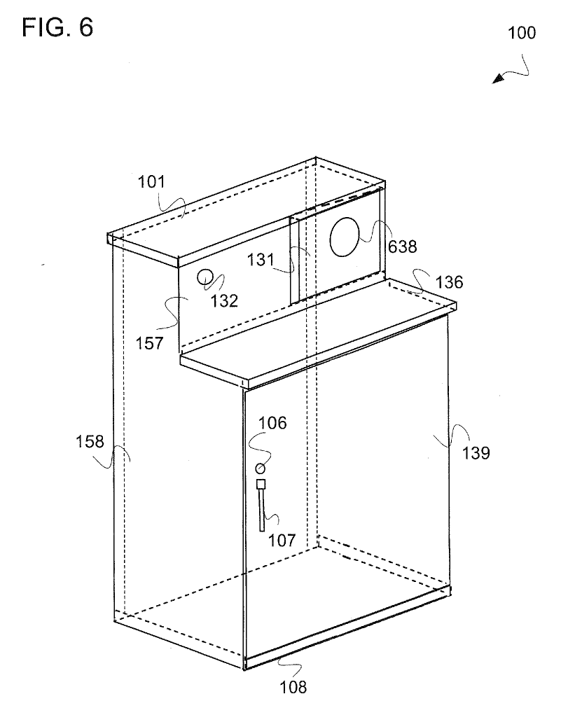

In some embodiments, the L-shaped cabinet 100 is subdivided into two main compartments. An upper compartment 144 of the L-shaped cabinet 100 (see FIG. 4) contains among other things, circuit breakers 123 and an electrical service meter 131 (see FIG. 4) that records the amount of electrical power used by a particular traffic-signal system. The meter itself protrudes from the upper portion and provides for easy viewing through a protective glass, Plexiglas™, Lexan™ or other type of transparent protective covering. The lower compartment 145 of the L-shaped cabinet 100 (see FIG. 4) contains among other things, the auxiliary battery supply for the L-shaped cabinet 100. The upper compartment 144 and contents therein are accessible through a locking front service door 109 (see FIG. 1); while the lower compartment is accessible through a locking rear service door 605 (see FIG. 6).

In some embodiments, the L-shaped cabinet 100 has a bolt pattern of, for example, center line (“CL”) CL×12-inches (CL×30.48-cm), 40.75-inches×18.5-inches (103.5-cm×46.99-cm), 34.5-inches×18.5-inches (87.63-cm×46.99-cm), 15-inches×6-inches (38.1-cm×15.24-cm) or some other bolt pattern that is commonly used in the industry. In some embodiments, the bolt pattern of the L-shaped cabinet 100 may be different based upon the efficiency of an alternative bolt pattern determined through empirical testing and/or modeling.

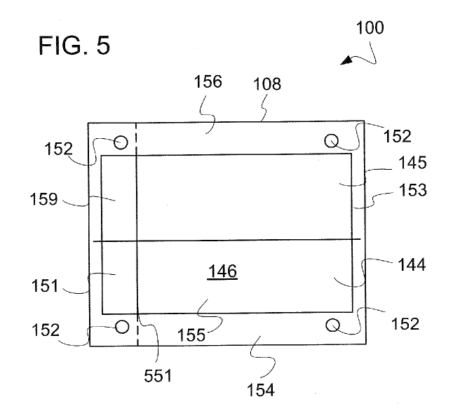

FIG. 5 is a bottom view of an L-shaped cabinet 100 with a metered wireway 151 (i.e., an opening extending through bottom 108 for street- and signal-light wires) for metered line voltage (e.g., line voltage signal power going to the signal lights), an un metered wireway 159 (i.e., an opening extending through bottom 108) for unmetered line voltage, four mounting openings 152, a main low-voltage bottom opening 153 to lower compartment 145 (i.e., an opening through bottom 108), a front 154, load side 155 (i.e., upper compartment 144), and rear 156. In some embodiments, the base itself is, for example, 17-inches (43.18-cm) in length, 23-inches (58.42-cm) wide, with the bolt pattern 14-inches×16-inches (35.56-cm×40.64-cm). In some embodiments, the openings for each bolt are positioned on the inside of the cabinet itself. In some embodiments, metered wireway 151 is separated from unmetered wireway 159 by a vertical divider structure 551. In some embodiments, upper compartment 144 is separated from lower compartment 145 by a horizontal divider structure 146.

FIG. 6 is a back perspective view of an L-shaped cabinet 100. Depicted is a side panel 158, an upper roof 101, a meter socket opening 638, a lower roof 136, a rear service door 139, a base plate 108, a three-point latch with padlocking provisions 107, a rear upper plate 157, a meter box 131, a window for a photocell 132, and a police lock 106.

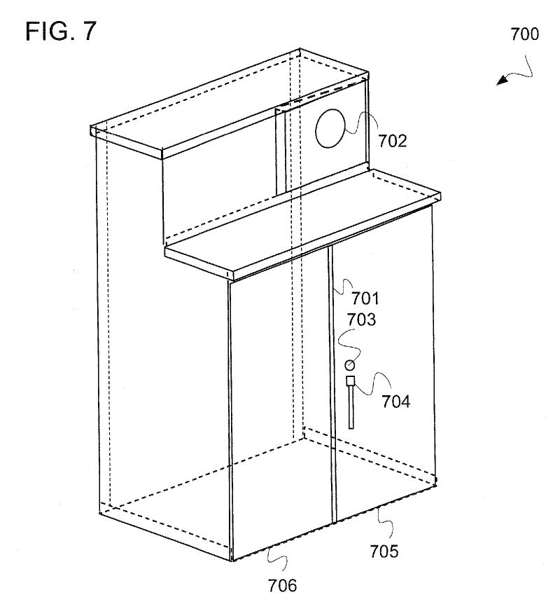

FIG. 7 is a back perspective view of an L-shaped cabinet 700 with split-rear service doors including, for example, a line of contact 701 for a pair of split-rear service doors 705 and 706, a meter socket opening 702, a police lock 703, and a three-point latch 704. In some embodiments, for example, much of the functionality described in FIG. 6 can be incorporated into the L-shaped cabinet 700 described in FIG. 7. Specifically, almost all of the features (e.g., upper roof 101, base plate 108, and a window 132 for photo cell) described in FIG. 6 can be incorporated into FIG. 7. Where FIG. 6 and FIG. 7 differ is that the latter has optional split-rear service doors.

In some embodiments, a clam-shell rear service door opening (described here but not shown in the figures) is used wherein access is gained to the rear of the L-shaped cabinet through two doors opening in a clamshell-like manner with a first upper door moving upward, and lower second door moving downward upon opening. As with the split-rear service doors, the doors making up the clamshell design can be locked via an internal lock or external three-point padlock configuration.

In some embodiments, a clam-shell front service-door opening is used (described here but not shown in the figures) wherein a first upper door moves upward, and lower second door moves downward upon opening. As with the split-rear service doors, the doors making up the clam-shell front service door opening can be locked via an internal lock or external three-point padlock configuration.

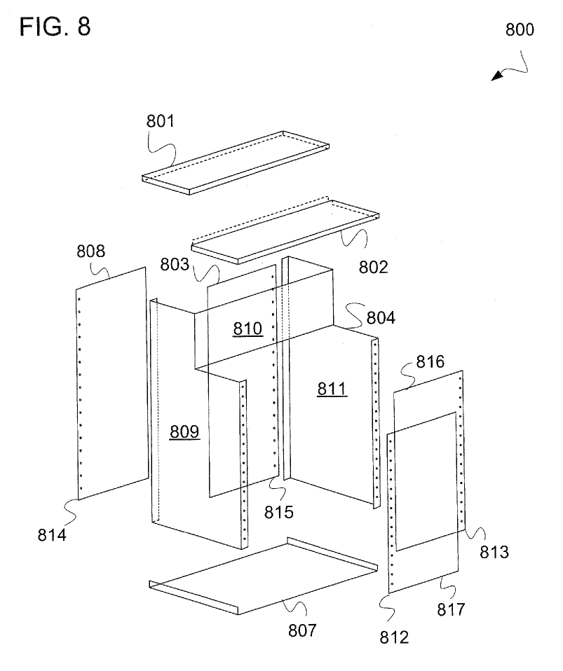

FIG. 8 is a back perspective exploded view of the various components that are assembled to create the L-shaped cabinet 800. These components include, for example, an upper roof 801, a lower roof 802, a front service door 808, an optional second front service door 803 (i.e., when a split-front-service-door configuration is implemented), a three-sided box frame 804, a rear service door 816, an optional rear service door 817 (i.e., when the split-rear-service-door configuration is implemented), and a base plate 807. In some embodiments, for example, optional doors are disclosed to support the above-described split-rear-service-door configuration, or an optional split-front-service-door configuration (described herein, but not referenced in the figures beyond the second front service door 808). Additionally included, for example, are a first major side 809, a second major side 810, and a third major side 811. Further included, in some embodiments, is a hinge 813, and an optional hinge 812 for the optional door 817 when a split-rear service door is implemented. In some embodiments, for example, a hinge 814 for a front door 808 is included, and an optional hinge 815 for an optional second front service door for a split-front-service-door configuration.

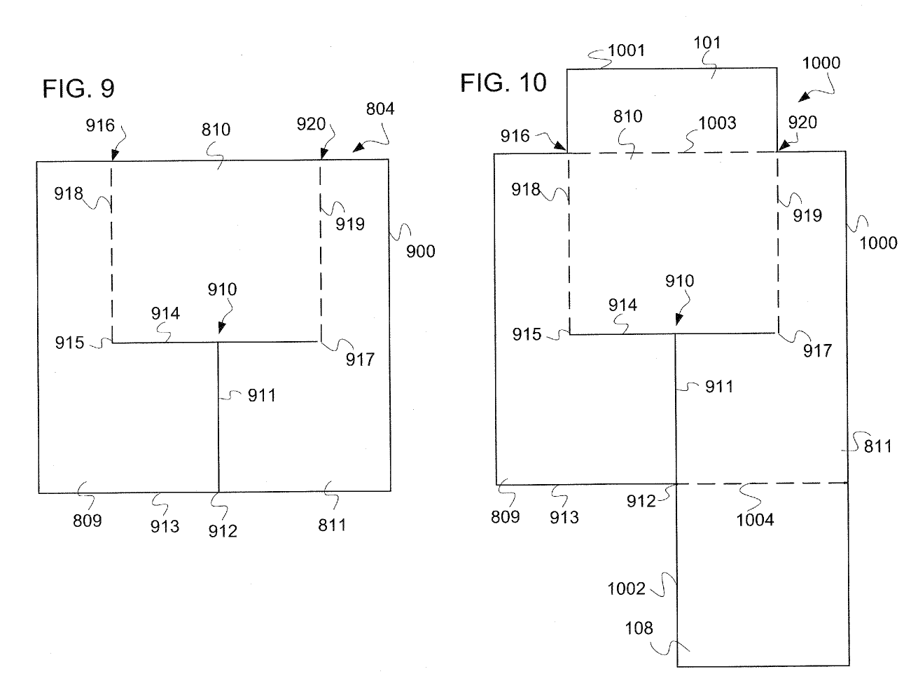

FIG. 9 is a cut-and-fold diagram for a first piece of sheet metal 900 that will form the L-shaped box frame 804 for the L-shaped cabinet 800. In some embodiments, the first piece of material is a generally rectangular piece of sheet metal 900. Sheet metal piece 900 has a T-shaped cut 910, the T-shaped cut 910 having a first cut 911 extending perpendicular from a center position 912 on the first edge 913, and a second cut 914 perpendicular to the first cut 911. The piece of sheet metal 900 is then folded from a first end 915 of the second cut 914 to a point 916 opposite the first edge 913 along a first fold line 918, and is also folded from a second end 917 of the second cut 914 to the point 920 opposite the first edge 913 along a second fold line 919, so as to define the three major sides (i.e., first L-shaped side 809, second side 810, and third L-shaped side 811 described above for FIG. 8). In some embodiments, additional details, such as folded edges (not shown here) are also included for hinges or structural stiffness.

FIG. 10 is a cut-and-fold diagram for a piece of sheet metal 1000 with portions for an upper roof 1001 and base plate 1002 that will form the L-shaped box frame 804 (modified to include upper roof 101 and base plate 108) for the service box. In some embodiments, sheet-metal piece 1000 has a generally rectangular center portion plus an upper-roof extension 1001 and a base extension 1002. Sheet-metal piece 1000 has a T-shaped cut 910, the T-shaped cut 910 having a first cut 911 extending perpendicular from a center position 912 at the end of the first edge 913, and a second cut 914 perpendicular to the first cut 911. The piece of sheet metal 1000 is then folded from a first end 915 of the second cut 914 to a point 916 opposite the first edge 913 along a first fold line 918, and is also folded from a second end 917 of the second cut 914 to the point 920 opposite the first edge 913 along a second fold line 919, so as to define the three major sides (i.e., first major side 809, second major side 810, and third major side 811 described above for FIG. 8). Next, an upper-roof extension 1001 is folded from a point 916 to a point 920 along a third fold line 1003 to form an upper roof 101, and the base extension plate 1002 is folded along a fourth fold line 1004 to an edge 913 to form a base plate 108. In some embodiments, additional details, such as folded edges (not shown here) are also included for hinges or structural stiffness.

In some embodiments, the L-shaped cabinet includes various folded or stamped pieces including, for example, a three-sided box frame, a back panel, a shelf rack, a shelf, a shelf stop, a base plate and bracket, a small lower door, a back panel rail, a dead front, a divider with knock outs, a front service door, a rear service door, a lower section roof, a door stiffener, a top vented brace, an upper roof, a wireway cover, a lower barrier, a raceway divider and a stand off. Each of these pieces is operative coupled to form a single L-shaped cabinet.

In some embodiments, the L-shaped cabinet can be constructed using an apparatus for folding a piece of sheet metal into a three-sided box frame, and then using the same or a different apparatus for folding separate pieces of metal into a back panel, a shelf rack, a shelf, a shelf stop, a base plate and bracket, a small lower door, a back panel rail, a dead front, a divider with knock outs, a front service door, a rear service door, a lower section roof, a door stiffener (or stiffeners), a top vented brace, an upper roof, a wireway cover, a lower barrier, a raceway divider, and a stand off. Once the various pieces that make up the service cabinet are formed, other apparatus are employed to attach these pieces together including, for example, an apparatus for attaching the back panel onto the back of the three-sided box frame using a lock-and-hinge mechanism, an apparatus for attaching the shelf rack and shelves onto the three-sided box frame, an apparatus for attaching the shelf stop into the three-sided box frame, an apparatus for attaching the three-sided box frame onto a base plate, an apparatus for attaching the front door to the three-sided box frame using a lock-and-hinge configuration, an apparatus for attaching various door stiffeners to the back and front service doors, an apparatus for inserting dividers into the three-sided box frame, an apparatus for attaching the upper roof to the top of the three-sided box frame, and an apparatus for attaching the top vent brace to the top of the three-sided box frame to cover the space between the upper roof and the top of the three-sided box frame.

In some embodiments, a kit including the following components is described. The components of such a kit could be assembled by one knowledgeable in the art into a finished L-shaped cabinet. The components in such a kit include, for example, a three-sided box frame, a back panel, a shelf rack, a shelf, a shelf stop, a base plate and bracket, a small lower door, a back panel rail, a dead front, a divider with knock outs, a front service door, a rear service door, a lower section roof, a door stiffener (or stiffeners), a top vented brace, an upper roof, a wireway cover, a lower barrier, a raceway divider, and a stand off. The components of this kit are, in some embodiments, attached to one another as described below.

In some embodiments, as alluded to above, the methods for fastening or attaching together the various components that form the L-shaped cabinet, include, for example, welding (MIG, TIG, spot etc.), bolting, riveting, folding, and/or the use of adhesives/glues/sticky foam tapes or other suitable fastening methods.

In some embodiments, the apparatus is an L-shaped cabinet, with two compartments corresponding to an upper and lower portion of the L-shape. In some embodiments, the L-shaped cabinet has a barrier separating the upper and lower compartments. In still other embodiments, the apparatus has a front door with a locking latch, and a rear door with a locking latch. In some embodiments, the L-shaped cabinet has a window for a photocell, a meter box, and one or more racks. In some embodiments, the L-shaped cabinet has a base plate with a standard bolt pattern, and an upper and lower roof. In some embodiments, the L-shaped cabinet has a main power supply and an auxiliary power supply.

In some embodiments, the present invention is a method that includes folding a first piece of sheet material into a three-sided box frame having three major sides including a first, second and third major side, wherein the first major side and third major side are L-shaped, and the second major side connects a vertical inner edge of the first major side to a vertical inner edge of the third major side in order to construct a frame for an L-shaped cabinet. In some embodiments, the present invention is described wherein the first piece of material is a generally rectangular piece of sheet metal. In some embodiments, the method is also described as that further includes making a T-shaped cut into the first piece of material, the T-shaped cut having a first cut extending perpendicular from a substantially center position on a first edge, and making a second cut perpendicular to the first cut, wherein the above described folding includes folding the first piece of material from a first end of the second cut to a point on the edge opposite the first edge along a first fold line, and from a second end of the second cut to a point on the edge opposite the first edge along a second fold line so as to define the three major sides. In some embodiments, the method includes a method that further includes folding at least three additional pieces of sheet metal into respective component pieces for an upper roof, a lower roof, and a base plate; and attaching these three respective component pieces to the three-sided box frame in order to construct an L-shaped cabinet that includes: the upper roof, the lower roof, and the base plate. In some embodiments, the method describes folding of the first piece of material to further form an upper roof from a portion of the first piece of material. In some embodiments, the method describes folding of the first piece of material to further form a base plate. In some embodiments, the method describes additional component pieces to include one or more racks. In some embodiments, the method describes the additional component pieces to include a meter box. In some embodiments, the method of the present invention further comprises welding together the three-sided box frame and at least some of a plurality of the additional component pieces. In some embodiments, the method of the present invention further comprises bolting together the three-sided box frame and at least some of a plurality of the additional component pieces.

In some embodiments, the present invention is an apparatus that includes an L-shaped cabinet comprising a three-sided box frame with a first major side, a second major side, and a third major side, wherein the first major side and third major side are L-Shaped, and the second major side connects a vertical inner edge of the first major side to a vertical inner edge of the third major side in order to construct an L-shaped cabinet, and wherein the box frame is operatively coupled to one or more additional component pieces, in order to construct an L-shaped cabinet. In some embodiments, the apparatus further comprises an upper roof operatively coupled to the three-sided box frame. In some embodiments, the apparatus further comprises a lower roof operatively coupled to the three-sided box frame. In some embodiments, the apparatus further comprises a base plate operatively coupled to the three-sided box frame. In some embodiments, the apparatus further comprises one or more racks operatively coupled to the three-sided box frame.

In some embodiments, the present invention is an apparatus that includes an L-shaped-cabinet means for storing electrical-power equipment. In some embodiments, the apparatus further includes means for distributing electrical power. In some embodiments, the apparatus further includes means for controlling traffic signals. In some embodiments, the apparatus further includes means for securing traffic-control equipment. In some embodiments, the apparatus further includes means for accessing stored electrical power. In some embodiments, the apparatus further includes means for accessing traffic-control equipment.

It is to be understood that the above description is intended to be illustrative, and not restrictive. Although numerous characteristics and advantages of various embodiments as described herein have been set forth in the foregoing description, together with details of the structure and function of various embodiments, many other embodiments and changes to details will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein,” respectively. Moreover, the terms “first,” “second,” and “third,” etc., are used merely as labels, and are not intended to impose numerical requirements on their objects.

What is claimed is:

1. A method comprising:
folding a first piece of sheet material into a three-sided box frame having three major sides including a first, second and third major side, wherein the first major side and third major side are L-Shaped, and the second major side connects a vertical inner edge of the first major side to a vertical inner edge of the third major side in order to construct the frame for an L-shaped cabinet.

2. The method of claim 1, wherein the first piece of material is a generally rectangular piece of sheet metal, the method further comprising:
cutting a T-shaped cut into the first piece of material, the T-shaped cut having a first cut extending perpendicular from a substantially center position on a first edge, and a second cut perpendicular to the first cut, and wherein the folding includes:
folding the first piece of material from a first end of the second cut to a point on the edge opposite the first edge along a first fold line, and from a second end of the second cut to a point on the edge opposite the first edge along a second fold line so as to define the three major sides.

3. The method claim 2, further comprising:
folding at least three additional pieces of sheet metal into respective component pieces for an upper roof, a lower roof, and a base plate; and
attaching the at least three respective component pieces to the three-sided box frame in order to construct an L-shaped cabinet that includes:
the upper roof;
the lower roof; and
the base plate.

4. The method of claim 1, wherein the folding of the first piece of material further forms an upper roof from a portion of the first piece of material.

5. The method of claim 1, wherein the folding of the first piece of material further forms a base plate.

6. The method of claim 1, wherein the additional component pieces include one or more racks.

7. The method of claim 1, wherein the additional component pieces include a meter box.

8. The method of claim 1, further comprising welding together the three-sided box frame and at least some of a plurality of the additional component pieces.

9. The method of claim 1, further comprising bolting together the three-sided box frame and at least some of a plurality of the additional component pieces.

10. An apparatus comprising, an L-shaped cabinet comprising a three-sided box frame with a first major side, a second major side, and a third major side, wherein the first major side and third major side are L-Shaped, and the second major side connects a vertical inner edge of the first major side to a vertical inner edge of the third major side in order to construct an L-shaped cabinet box frame, and wherein the box frame is configured to be operatively coupled to one or more additional component pieces, in order to construct an L-shaped cabinet.

11. The apparatus of claim 10, further comprising an upper roof operatively coupled to the three-sided box frame.

12. The apparatus of claim 10, further comprising a lower roof operatively coupled to the three-sided box frame.

13. The apparatus of claim 10, further comprising a base plate operatively coupled to the three-sided box frame.

14. The apparatus of claim 10, further comprising one or more racks operatively coupled to the three-sided box frame.

15. The apparatus of claim 10, further comprising:
a separation structure that separates a low-voltage compartment from an unmetered line-voltage compartment and a metered line-voltage compartment;
a provision for exposing a photocell mounted interior to the cabinet; and
a provision for attaching an connecting a meter socket between the unmetered line-voltage compartment and the metered line-voltage compartment.

16. An apparatus comprising:
L-shaped-cabinet means for storing electrical-power equipment;
means for distributing electrical power; and
means for separating a low-voltage compartment from a line-voltage compartment.

17. The apparatus of claim 16, further comprising means for controlling traffic signals.

18. The apparatus of claim 16, further comprising means for securing traffic-control equipment.

19. The apparatus of claim 16, further comprising means for accessing stored electrical power.

20. The apparatus of claim 16, further comprising means for accessing traffic-control equipment.
